(19) United States
(12) Patent Application Publication
(10) Pub. No.: US 2024/0087759 A1
(43) Pub. Date: Mar. 14, 2024

(54) XENON-ENHANCED, AMMONIA BORANE-FILLED BORON NITRIDE NANOTUBE FUSION TARGETS

(71) Applicant: BNNT, LLC, Newport News, VA (US)

(72) Inventors: R. Roy WHITNEY, Newport News, VA (US); Lyndsey R. SCAMMELL, Newport News, VA (US)

(21) Appl. No.: 18/262,695

(22) PCT Filed: Jan. 25, 2022
(86) PCT No.: PCT/US2022/013619

§ 371 Date: Jul. 24, 2023

Related U.S. Application Data
(60) Provisional application No. 63/141,419, filed on Jan. 25, 2021.
(60) Provisional application No. 63/141,574, filed on Jan. 26, 2021.

(51) Int. Cl. G21B 1/19; B82Y 40/00; H05H 6/00

(52) U.S. Cl. CPC G21B 1/19; B82Y 40/00; H05H 6/00

(57) ABSTRACT

This disclosure relates to the use of hydrogen storage compounds and high atomic weight elements in boron nitride nano tube (BNNT) fusion targets. Such targets may be used as targets for high power pulsed laser beams to produce proton ¹¹B fusion reactions. BNNT fusion targets having as additives a hydrogen storage compound (such as ammonia borane) and a high atomic weight element (such as xenon), and methods for making the same, are disclosed.

### STATEMENT REGARDING GOVERNMENT SUPPORT

None.

### FIELD OF THE INVENTION

The present disclosure relates to incorporating hydrogen storage compounds and high atomic number elements into boron nitride nanotubes (BNNTs), and more particularly, into boron nitride nanotube (BNNT) fusion targets.

### BACKGROUND—INTRODUCTION

Fusion research has been active for over fifty years, and functioning, effective commercial reactors have yet to be achieved. Confining charged particles, numerous instabilities, and the large amount of energy required to sustain a fusion reaction continue to be challenges. There have been numerous configurations proposed to confine charged particles accelerated by electromagnetic means.

Laser technology has developed to the point where sustaining fusion reactions is achievable. The fusion reaction of interest involves the hydrogen nuclei with boron isotope 11, or ¹¹B. This reaction is known as the pB11 reaction. Each pB11 reaction produces three alpha particles, with an energy gain of 8.2 MeV. The energy gain can be converted into usable energy (e.g., electrical or heat energy). The pB11 reaction has numerous advantages, including abundant raw materials, a high energy yield, and less radioactivity per unit of energy produced when compared to coal burning.

The ignition of the pB11 reaction is considerably difficult. Some proposed methods involve lasers to create ¹¹B plasma, and separate lasers to accelerate a stream of protons into the plasma. The proton beam produces a tenfold increase of boron fusion, because protons and boron nuclei directly collide. Some methods require a magnetically confined plasma. The common aspect, though, is a fusion target providing sufficient ¹¹B to maximize the proton and boron nuclei interactions.

What is needed, then, is a fusion target providing the combination of sufficient ¹¹B and sufficient protons to maximize the proton and boron nuclei interactions. What is further needed is a boron fusion target having enhanced mass density and electron density, to increase the energy gain from the reaction.

### BRIEF SUMMARY

This disclosure relates to the use of xenon and other high atomic number elements as an additive to low atomic number materials such as those with lithium, beryllium, boron, carbon, nitrogen, fluorine, oxygen, and specifically BNNT filled with AB or related borane molecules and compounds, to enhance the electron density, mass density and the conversion of energy from the laser beam and energetic electrons to photons when the materials are being irradiated as targets by intense pulsed laser beams, including the goal of utilizing the enhanced targets to produce proton plus ¹¹B (pB11) fusion reactions.

A variety of hydrogen storage compounds are available for use as proton sources, and may be used without departing from the present approach. In this disclosure, ammonia borane, abbreviated as AB, and having the chemical formula (H₃NBH₃), is used as an example of a hydrogen storage compound and proton source. AB has been included in multiple boron nitride based (BN) materials, including, for example, BNNTs, in part because AB is considered to a good candidate for hydrogen storage. Other example compounds for H storage include methane ammonia, alane (Al₃H₉), boron hydrides (such as diborane, B₂H₆), metal hydrides (such as MgH₂, NaAlH₄, LiAlH₄, LiH, LaNi₅H₆, TiFeH₂, palladium hydride, organoboranes, and hydrocarbons.

When intense pulsed laser beams of short pulse durations interact with materials, there are typically a series of compression waves of increased mass density and increased electron density that propagate into and possibly through the material. Under the influence of the intense laser pulse, the wave of compressed electrons can separate from the wave of compressed and more massive ions that have lost their electrons to the wave of electrons, and thereby create a wakefield type of acceleration electromagnetic field that will accelerate lighter ions such as protons and electrons. The strength and range of the wakefield acceleration depends on multiple parameters including the electron density and the intensity of the photon field generated by a combination of the laser and of photons generated by electron interactions with the ions and other electrons.

The contribution of a high atomic number element, such as xenon, to the target is that the high atomic number element can generate both an increase in electron density being a relatively high atomic number element, and an increase in photons in the x-ray and even gamma ray energies regions by an increase of bremsstrahlung production as compared to the bremsstrahlung from the low atomic number materials in the target. There is a positive feedback where these increases in bremsstrahlung photons increase the number of energetic electrons that then further increase the bremsstrahlung production with associated further increases in the electron densities, mass densities and wakefield acceleration including the wakefield acceleration of the protons that contribute to the pB11 fusion reactions. The utilization of BNNT filled and coated with a hydrogen storage compound such as AB, and a high atomic number element, such as xenon, supports the distribution of hydrogen and ¹¹B atoms within the target material for optimization of the pB11 fusion reactions.

Some embodiments of the present approach take the form of an ¹¹B fusion target. The fusion target includes boron nitride nanotubes (BNNT), a hydrogen storage compound that includes, or is, ammonia borane, and a high atomic number element. A BNNT material has a plurality of nanotubes, each of which has an exterior nanotube surface and an interior nanotube surface. Preferably, the BNNT material is a high quality BNNT material produced by the HTP synthesis method. In some embodiments, the hydrogen storage compound may also include one or more of methane, ammonia, alane (Al₃H₉), a boron hydride, diborane (B₂H₆), a metal hydride, MgH₂, NaAlH₄, LiAlH₄, LiH, LaNi₅H₆, TiFeH₂, palladium hydride, an organoborane, and a hydrocarbon. In some embodiments, the high atomic number element is xenon.

In some embodiments, the hydrogen storage compound is a coating on external nanotube surfaces of the BNNT material. In some embodiments, the hydrogen storage compound is also present as a coating on interior nanotube surfaces of the BNNT material. In some embodiments, the hydrogen storage compound is dispersed throughout the BNNT material.

In some embodiments, the high atomic number element is a coating on at least a portion of the ammonia borane coating on external nanotube surfaces of the BNNT material. The high atomic number element may be a coating on at least a portion of the ammonia borane coating on external nanotube surfaces of the BNNT material and at least a portion of the ammonia borane coating on interior nanotube surfaces of the BNNT material. In some embodiments, the high atomic number element is dispersed throughout the BNNT material.

In some preferred embodiments of the present approach, the hydrogen storage compound is ammonia borane, and the high atomic number element is xenon. The ammonia borane is dispersed throughout the BNNT material, and coats portions of the interior surfaces and exterior surfaces of nanotubes in the BNNT material. The xenon is also dispersed through the BNNT material, and coats portions of the interior surfaces and exterior surfaces of nanotubes in the BNNT material (including the ammonia borane coating). In a demonstrative embodiment, an ¹¹B fusion target is made of a BNNT material having a coating of ammonia borane and a coating of xenon. The target is suitable for use with intense pulsed laser beams for achieving proton ¹¹B fusion.

Some embodiments of the present approach take the form of methods for forming an ¹¹B fusion target. Generally, a hydrogen storage compound comprising ammonia borane is dispersed into a BNNT material in a reaction vessel, then a high atomic number element is dispersed into the BNNT material. In some embodiments, the reaction vessel is under vacuum for either or both the hydrogen storage compound dispersing and/or the high atomic number element dispersing. The hydrogen storage compound may include one or more other compounds selected from methane, ammonia, alane (Al₃H₉), a boron hydride, diborane (B₂H₆), a metal hydride, MgH₂, NaAlH₄, LiAlH₄, LiH, LaNi₅H₆, TiFeH₂, palladium hydride, an organoborane, and a hydrocarbon. In some preferred embodiments, the high atomic number element is xenon.

In some embodiments, BNNT fusion target may be made in a gas-phase process. The hydrogen storage compound may be heated to a temperature sufficient to evaporate the hydrogen storage compound and form an evaporated hydrogen storage compound in the reaction vessel. The reaction vessel may then be cooled to a temperature sufficient to sublimate the evaporated hydrogen storage compound onto surfaces of the BNNT material, to form an ammonia borane-coated BNNT material. Next, the ammonia borane-coated BNNT material is cooled to a temperature below the melting point of the high atomic number element. It should be appreciated that the process may be repeated to form multiple layers of the hydrogen storage compound and/or the high atomic number element.

In some embodiments, the BNNT fusion target may be made using a solution-phase process. The hydrogen storage compound and the BNNT material may be placed in solution, together or in compatible solvents. The hydrogen storage compound may be dispersed throughout the BNNT material through mixing a solution having both components. The solvent may be removed to form a hydrogen storage compound-coated BNNT material (e.g., an ammonia borane-coated BNNT material). Then, the hydrogen storage compound-coated BNNT material may be cooled to a temperature below the melting point of the high atomic number element, and the high atomic number element may be dispersed through the cooled, hydrogen storage compound-coated BNT material, to deposit a layer of the high atomic number element on the cooled, hydrogen storage compound-coated BNT material. It should be appreciated that the process may be repeated to form multiple layers of the hydrogen storage compound and/or the high atomic number element.

### DESCRIPTION OF THE DRAWINGS

FIG. 1 shows the average electron density vs. atomic number.

FIG. 2 illustrates the relative sizes of BNNTs, AB molecules, and xenon atoms.

FIG. 3 shows a TEM image of BNNTs with AB present mostly on the inside of the BNNTs.

FIG. 4 shows a TEM image of BNNTs with AB present on the inside and outside of the BNNTs.

FIG. 5 shows a TEM image of BNNTs without AB present.

FIG. 6 shows a TEM image of BNNTs without AB present along with BN nanocages.

FIG. 7 illustrates a gas-phase process for adding a hydrogen storage compound and a high atomic number element to a BNNT material, according to one embodiment of the present approach.

FIG. 8 illustrates a solution-phase process for adding a hydrogen storage compound and a high atomic number element to a BNNT material, according to one embodiment of the present approach.

### DETAILED DESCRIPTION

Described herein are various embodiments of boron nitride nanotube (BNNT) targets for fusion reactions, and methods for making the same. Under the present approach, BNNTs may be filled with a hydrogen storage compound, such as ammonium borane (AB), and a high atomic number element, such as xenon, and used as a target for fusion reactions between the protons in the AB and the ¹¹B atoms in the BNNTs and AB. Both the BNNT and the AB can be made with ¹¹B rather than natural boron to optimize the presence of ¹¹B in the target. The following description illustrates embodiments of the present approach in sufficient detail to enable practice of the present approach. Although the present approach is described with reference to these specific embodiments, it should be appreciated that the present approach can be embodied in different forms, and this description should not be construed as limiting any appended claims to the specific embodiments set forth herein. Rather, these embodiments are provided so that this disclosure will be thorough and complete, and will fully convey the scope of the present approach to those skilled in the art.

It should be appreciated that a variety of BNNT materials are presently available, and that the quality of BNNTs depends on the synthesis and refinement processes used to produce the BNNTs. BNNT can be synthesized with a variety of methods to include high temperature, high-pressure (HTP) methods, CVD methods and ball milling methods. The present approach may be practiced with most BNNT materials currently available, although the relative performance of the fusion target will depend on the quality of BNNT material used. HTP methods can produce high quality BNNTs, i.e., a few-wall (e.g. 1-10 walls, and mostly 2-3 walls) with a minimal amount of boron particulates, amorphous boron nitride (a-BN), BN nanocages, BN nanosheets, and any other non-BNNT materials. As used herein, the term “high quality” BNNT materials generally means that the BNNTs have: 1) high crystallinity, i.e., less than one crystal defect per one hundred diameters of length; 2) few walls, i.e., 70% of the BNNTs have 3 or fewer walls; 3) small diameters, i.e., 70% of the BNNTs have diameters below 8 nm; 4) about 80%, +/−5%, of the BNNTs have length:diameter aspect ratios greater than 100:1; and 5) 70%, +/−5%, of the BNNTs have lengths greater than 2 microns. CVD and ball milling methods typically produce BNNTs with 10-50 walls and more crystal defects than one per one hundred diameters of length. As a result, BNNTs produced through CVD or ball milling are not the most suitable options for the present approach, but nonetheless may be used. For pB11 fusion targets, having the boron particles present may benefit fusion reactions in some embodiments. For some pB11 fusion processes and embodiments having the boron particles, a-BN, BN nanocages and BN nanosheets removed through purification processes may be preferred, because this typically increases the surface area for the high atomic number element (e.g., xenon) and hydrogen storage compound (e.g., AB) to cover. The purification processes typically also open the ends of the BNNT tubes that might otherwise be covered with a-BN, BN nanocages and/or BN nanosheets, thereby allowing the additives to advantageously enter into and fill the interior of the nanotubes.

Under the present approach, “high quality BNNTs,” such as those produced by BNNT, LLC (Newport News, Virginia) are preferable for use as the BNNT material in most embodiments. Such BNNTs are produced by catalyst-free, high temperature, high pressure synthesis methods, have few defects, no catalyst impurities, 1- to 10-walls with a peak in wall distribution at 2-walls, and rapidly decreasing with larger number of walls. BNNT diameters typically range from 1.5 to 6 nm but may extend beyond this range, and lengths typically range from a few hundred (e.g., about 1 to about 5, and in some embodiments, about 2 to about 5, and in some embodiments, about 3 to about 5, wherein the term “about” in this context means+/−0.5) of nm to hundreds of microns, though depending on the synthesis process and conditions the lengths may extend beyond this range. For the as-produced BNNT material, high quality BNNTs typically make up about 50% of the bulk material, and boron particles, amorphous BN, and h-BN may be present as a result from the synthesis process. As used herein, “boron particle(s)” refers to free boron existing apart from other boron species. The synthesis operating conditions may be adjusted to change the composition of boron particles, relative to the amorphous BN and h-BN species, remaining in the BNNT material. Various purification processes can be used to remove boron particulates, BN, and h-BN, including those disclosed in co-pending International Patent Application No. WO 2018/102423 A1, filed Nov. 29, 2017, which is incorporated by reference in its entirety. It should be appreciated that boron particles may be advantageously retained in some embodiments.

A fusion target based described herein may be irradiated by one or more intense pulsed laser beams. Fusion targets may be formed from various low atomic number elements, such as lithium, beryllium, boron, carbon, nitrogen, fluorine, oxygen, and compounds and nanostructures made therefrom. BNNTs provide several advantages for use as fusion targets including the ability to control the target structure, control the density distribution of protons from AB, and electron density from the inclusion of xenon. In some embodiments of the present approach, a high atomic number element, such as xenon, may be used as an additive to the fusion target. In some embodiments of the present approach, a hydrogen storage material, may be used as an additive to the fusion target. In some embodiments, both a high atomic number element and a hydrogen storage material may be used as additives to the fusion target. These additives enhance the electron density and mass density of the fusion target, and improve the conversion of energy from the laser beam and energetic electrons to photons when the fusion target is irradiated by intense pulsed laser beams.

Under the present approach, the preferred low atomic number elements are boron and nitrogen, and preferably in BNNT nanostructures. It should be appreciated that fusion targets may comprise other low atomic number elements. In general, a low atomic number element as disclosed herein has an average atomic number Z of 10 or lower. For example, the average Z for BN is Z of 6. Pulsed laser beams include beams at optical and near infrared wavelengths of light, beams in the range of ultraviolet (UV) and x-rays, of intensities above 10¹⁶ W/cm² and pulse durations below 500 picoseconds (ps), and for fusion applications, beams with intensities above 10¹⁹ W/cm² and pulse durations below 100 femtoseconds (fs). For the avoidance of doubt, the phrase “intense pulsed laser beam” as used herein generally includes beams having intensities above 10¹⁶ W/cm². When a pulsed laser beam interacts with a fusion target, there are typically compression waves of increased density including increased electron density that propagate into and possibly through the fusion target. There are also reflected electron and mass density waves. Under the influence of an intense pulsed laser beam, the wave of compressed electrons can separate from the wave of compressed and more massive ions that have lost their electrons to the wave of electrons, and thereby create a wakefield type of acceleration electromagnetic field that will accelerate lighter ions, such as protons. The strength and range of the wakefield acceleration depends on multiple parameters, such as the electron density and the intensity of the electromagnetic fields generated by the photon field, which is generated by a combination of the laser and of photons generated by electron interactions with the atoms, ions and other electrons. The resultant plasma may degenerate if the density of electrons is high enough. One benefit of a degenerate plasma in some embodiments is that the process of electrons losing energy from radiation that occur with electron-electron scattering are reduced because the lower energy states of the plasma are not available to the scattered electrons. The enhanced electron density coming from the presence of the xenon will initiate the preferred degenerate plasma at lower laser intensities.

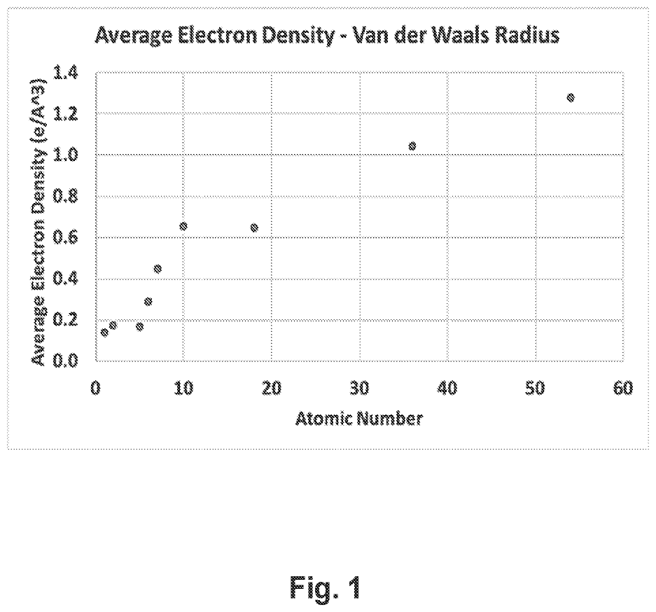

In embodiments of the present approach, the addition of a high atomic number element or material, such as xenon, to the fusion target increases the electron density of the fusion target. Xenon is a high atomic number element (Z=54) with electrons within the Van der Waals radius of 216 picometers (pm). The preference for xenon over other high atomic number elements is that xenon is a non-reactive gas and can easily be removed from the target residue after the fusion reaction. Other high atomic number elements such as iodine, tin, etc., that have similar electron densities, can be chemically bonded in the target residues, and as a result require chemical processing to remove. FIG. 1 shows the average electron density versus atomic number for several low atomic number elements, and the noble gases from helium to xenon. Using the BN average and xenon as examples, xenon has 5.2 times the average electron density compared to BN. Additionally, the high atomic number element, such as xenon, will increase in photons in the x-ray energy region (photons 100 eV-100 keV) and the gamma ray energy region (photons >100 keV), by an increase in bremsstrahlung production of photons from electrons scattering from the high atomic element nuclei, as compared to the bremsstrahlung from the low atomic number elements in the fusion target. The xenon critical energy for generating bremsstrahlung gammas is near 12 MeV, compared to the critical energy of carbon as representative for the BN average, as an example low atomic number element, which is near 82 MeV. An electron loses more energy by bremsstrahlung above the critical energy, and the electron loses more energy ionization below the critical energy. Ionization losses remove energy from most processes of interest, and the photons from bremsstrahlung from ions contribute to many processes of interest. For example, in first order a several MeV photon has 1/α, i.e., 137, (where α is the fine structure constant that is near 1/137) times higher cross section to produce a reaction with a nuclei as compared to a several MeV electron. Consequently, enhancing the production of x-ray and gamma photons can be of value in some embodiments. Note, some laser facilities have used fusion targets with high atomic number elements as a portion of the target to act as a reflector for x-rays produced in the laser beam target interactions. The present approach is different, and more effective. For example, the xenon or other high atomic number element is not being used as a reflector external to the target reactants, but rather an enhancer of electron densities within the target reactant themselves and bremsstrahlung production that result in further enhancement of the densities and electromagnetic fields generated within the target.

For pB11 fusion, protons from below 100 keV to several MeV with the highest cross section near 665 keV will fuse with the ¹¹B in the fusion target to make three alpha (⁴He) particles, with typical energies near 2900 keV for 665 keV protons. The alpha particles then collide with surrounding protons and after two or more collisions this results in new protons near the 665 keV region that then continue the pB11 fusion process with surrounding ¹¹B atoms. The combination of the wakefield acceleration of the protons and the pB11 fusion process itself produces the protons with the energies in the region needed for the overall generation of energy from the fusion process.

As mentioned above, a hydrogen storage material may be used as an additive to the fusion target. In embodiments of the present approach, the preferred hydrogen storage material is ammonia borane (also referred to as borazane), abbreviated in this disclosure as AB, and having the chemical formula (H₃NBH₃). AB is effective as an additive and hydrogen storage material in multiple boron nitride (BN) materials, including BNNTs. Further, AB provides a controllable source of hydrogen atoms to provide the protons for pB11 fusion. It should be appreciated that other hydrogen storage materials may be used without departing from the present approach. Examples of other hydrogen storage materials include, but are not limited to, methane, ammonia, alane (Al₃H₉), boron hydrides (such as diborane, B₂H₆), metal hydrides (such as MgH₂, NaAlH₄, LiAlH₄, LiH, LaNi₅H₆, TiFeH₂, palladium hydride, organoboranes, and hydrocarbons.

A combination of multiphoton inverse bremsstrahlung and pondermotive forces along with other laser beam-materials interactions produce the waves of compressed electrons, compressed ions and compressed material including enhanced electron and ion densities including protons for inducing pB11 fusion. These waves are initiated by the photons in the front side of the laser beam pulse, but these waves move at less than the speed of light. Consequently, the photons in the middle and back side of the laser beam pulse catch up to the initial waves and further increase the compressed waves intensities. The fields can become of sufficiently high field strength to produce multi MeV electrons and even multi tens of MeV electrons. In addition, multi hundreds of keV protons and even multi MeV protons are produced when protons are present. If there are high Z atomic number elements materials, such as xenon, present, then in addition to locally having the benefit of the high Z electron densities, the bremsstrahlung process generates more photons from the more energetic electrons, especially from those electrons above 12 MeV as discussed above. There is a positive feedback where these increases in bremsstrahlung photons increases the photon and wakefield type intensities, that in turn increase the number and energies of energetic electrons, that then further increase the bremsstrahlung production with associated further increases in the electron densities, mass densities and wakefield type acceleration of the ions of interest to include protons.

In principle, most high atomic number element can be utilized to provide the benefits of enhanced electron densities and enhanced bremsstrahlung discussed above. Xenon is a preferred high atomic number element because it is a noble gas that minimally interferes with other materials, chemical, or other process that may be of interest in the target material and is easily removed from the target residue as discussed above. For fusion target preparation, xenon will diffuse in and adsorb on a number of materials of interest, especially if the temperature of the target is cooled to near xenon's melting point of −111.75° C. If xenon is used, it may be preferable to handle the diffusion and adsorption of the xenon separately for each layer in a multilayer fusion target. High pressure can also be utilized for the infusion of xenon within the low atomic number target materials. For noble gases, krypton has Z=36, but a higher critical energy (near 19 MeV) that would generate less bremsstrahlung production of photons, and radon has a critical energy near 8 MeV, but radon is radioactive and consequently not preferred. Additionally, xenon has better adsorption compared to most materials, and particularly compared to lower atomic number noble gases. As an example of the gain in electron density, if xenon is added such that xenon comprises 11% the number of atoms of low atomic number materials in a target that has a Z of carbon, i.e. 6, the average starting electron density of the target will be increased by 50% assuming that there is otherwise no change in the materials structure of the target.

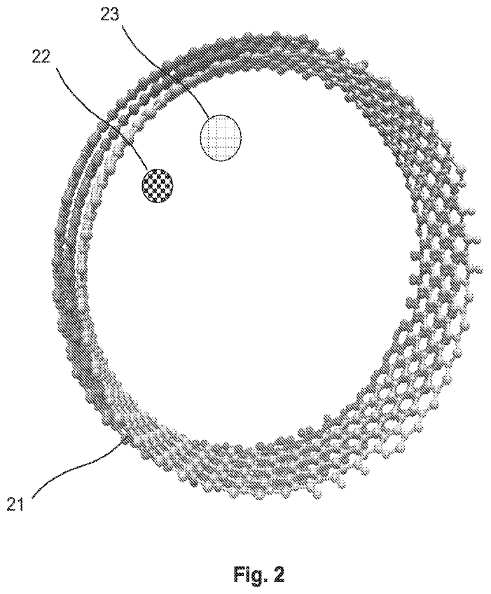

There are a variety of methods for adding a hydrogen storage material into the fusion target. In some embodiments, the hydrogen storage material may be coated onto and fill the fusion target. Gas and liquid-based processes are typical. Liquids may involve one or more solvents that are subsequently evaporated. For example, AB may be added to a BNNT fusion target, primarily as a coating. AB's melting point is 97.6° C. or within a few degrees of this value when AB is near other materials, and AB is stable at room temperature. Each molecule of AB contributes six hydrogen atoms, so loading BNNT with AB at preferred concentrations allows for control of the amount of hydrogen available to contribute protons to the fusion target for pB11 fusion processes. The amount of material provided to the process determines the final concentration for the process. An AB molecule is less than roughly 0.3 nm in size, and therefore AB molecules easily fit within the typical BNNT inner diameter of about 1.5 nm-5 nm for the common 2 and 3 wall BNNTs, particularly with high quality BNNTs. Also, the diameter of xenon is 0.43 nm. FIG. 2 is an illustration comparing the relative sizes of a 4 nm diameter, 3-wall, BNNT 21 with an AB molecule 22 and a xenon atom 23. As can be seen, the high atomic number element 23 and the hydrogen storage material 22 easily fit within the typical high quality BNNT. Both the xenon atoms and AB molecules fit well within the inner diameter of BNNTs. As such, when added using an appropriate process, both xenon and AB fit within BNNTs, and also can coat the interior and outer surfaces of the BNNTs. They are both gases in their respective coating conditions and as such coat both the interior and exterior surfaces of the BNNTs. Further, AB and xenon will coat BNNT at temperatures near their melting points since both have increasing vapor pressures as they near their melting points. In preferred embodiments, the sequence is to first coat the BNNT surfaces with AB, and then cool the material to just below the xenon melting point, and then coat with xenon in its gaseous phase coming from xenon vapor that is vapor pressure associated with the xenon liquid. The xenon gas will adequately adsorb both within the BNNT and on the surfaces of the BNNT, including those surfaces with a coating of AB. The amounts of AB in a given portion of the target can be controlled by the AB deposition processes utilized for some embodiments; multiple processes have been developed and are discussed below. The utilization of BNNT fusion targets filled and coated with AB and xenon supports the fine and uniform distribution of hydrogen and ¹¹B atoms within the target material for optimization of the pB11 fusion reactions. In the case of AB, the filling reaction is efficient (e.g., most AB molecules enter the nanotube) such that the final mass loading of AB in BNNT can be precisely controlled by adding that amount as a reactant (e.g., add 0.8 g of BNNT and 0.2 g of AB for a final mass loading of 20 wt % AB inside of BNNT). The efficiency of the reaction (reactant ratio and final loading) should be determined for each hydrogen storage compound.

In the present approach, one or more hydrogen storage compounds may be added to a BNNT material, through additive processes including, but not limited to, gas-phase filling and solution-phase filling. This description uses AB as a preferred hydrogen storage compound for describing examples, but it should be appreciated that other hydrogen storage compounds may be used. BNNTs may have different Brunauer-Emmett-Teller specific surface areas, ranging from 50-500 m²/g, and the AB will collect on the interior and exterior nanotube surfaces using either gas-phase filling or solution-phase filling.

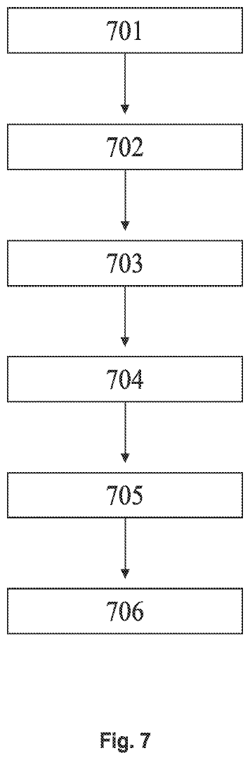

FIG. 7 is a flowchart showing a process for adding a hydrogen storage compound to a BNNT fusion target through a gas-phase additive process, according to one embodiment of the present approach. The reactant mass ratio will vary based on the efficiency of the filling process and desired final mass ratio. It is specific to the conditions and hydrogen storage compound (e.g., 0.9 g of BNNT and 0.1 g of AB to achieve 10 wt % loading). In step 701, the BNNTs and hydrogen storage compound are added to a reaction vessel at the desired mass ratio. The components may be added to the same reaction vessel, or if the hydrogen storage compound is to be forcefully flowed through the BNNT material, then the reaction vessel may include a separate volume to contain the hydrogen storage compound. The BNNT material may be in any formfactor, such as a BNNT powder, a BNNT mat, a BNNT buckypaper, or a BNNT puffball, for example. In some embodiments, the BNNT material may have been processed to open the ends of some or most nanotubes in the BNNT material, thereby allowing the hydrogen storage compound to enter and coat the interior surfaces of the nanotubes (e.g., at a later step). For example, in some embodiments the BNNT material may be heated at about 190° C. to 250° C., for about 12 minutes to about 2 h, and preferably in a vacuum, to remove any residual water or solvents from prior processing. The contents may be added to the reaction vessel at room temperature and pressure, if desired. Depending on the hydrogen storage compound, both the BNNT material and the hydrogen storage compound may be solid at room conditions. In step 702, the hydrogen storage compound is dispersed into the BNNT material. For example, the reaction vessel may be heated to evaporate the hydrogen storage compound. In embodiments with a separate housing for the hydrogen storage compound, the separate housing may be heated to evaporate the hydrogen storage compound, which is then forcefully flowed through the BNNT material. In some embodiments, the reaction vessel may be under a vacuum. In some embodiments, the evaporated hydrogen storage compound may be forced to flow through the BNNT material, such as through a pressurized nozzle or other device known in the art. In some embodiments, the BNNT material may be cooled during the forced flow of hydrogen storage compound, to create a temperature gradient and initiate the localized sublimation. In step 703, the hydrogen storage compound is given sufficient time to thoroughly disperse through and into the BNNT material. The time will necessarily depend on the particular embodiment. In step 704, after sufficient time to allow the hydrogen storage compound to disperse through the BNNT material, the reaction vessel may be cooled to sublime the hydrogen storage compound onto the exterior surfaces and, if open-ended nanotubes are present, the interior surfaces of the BNNT material.

In step 705, the BNNT material filled with hydrogen storage compound is cooled to a temperature below the melting point of the high atomic number element. For example, when using xenon as the high atomic number element, the BNNT material filled with hydrogen storage compound is cooled to near xenon's melting point of −111.75° C., such as about −112° C. to −115° C. In step 706, after the target temperature is reached, xenon gas may be flowed into a chamber housing the cooled BNNT material filled with hydrogen storage compound. The xenon gas will adsorb in the interior of the BNNT, and on the interior surfaces and exterior surfaces of the BNNT, including those surfaces with a coating of AB. The specific processing conditions for xenon coating may be determined by the person having an ordinary level of skill in the art, with routine experimentation, for a particular embodiment. Once loaded with xenon, the target should be kept below 190° C. so that the xenon vapor pressure is kept below 1 Pa thereby providing an indefinitely long target storage life. It should be appreciated that the process may be repeated to increase the content of either or both the hydrogen storage compound and/or the high atomic number element, including building multiple layers of either or both components.

For gas-phase filling, the additive process involves placing the BNNT sample and hydrogen storage compound into a reaction vessel. The contents are then placed under vacuum (e.g., about 10⁻³-10⁻² Torr in experimental runs). The contents may then be heated sufficiently to evaporate the hydrogen storage compound (preferably without decomposition), and then the hydrogen storage compound is allowed to intermix with the BNNTs for a desired reaction time before being allowed to sublime on the BNNT interior and exterior surfaces. The extent and efficiency of the gas-phase filling reaction may be controlled by the temperature of the reaction vessel (heated by, e.g., an oil bath), the duration of heating, and the properties of the BNNT form factor used. It should be appreciated by the person of ordinary skill in the art that the ideal reaction conditions for a particular embodiment will necessarily depend on the particular embodiment, and that routine experimentation may be used to determine acceptable reaction conditions for a given embodiment. For example, with AB as the hydrogen storage compound, the reaction vessel may be heated to 90-110° C. to sublime the AB for 5 min-12 h. AB is solid and stable in air at room temperature, and AB's melting point is 97.6° C., though the melting point may vary a few degrees depending on the presence of other materials in the reaction vessel. Temperatures above 110° C. may cause AB to decompose into H₂, which would not be preferred for filling a BNNT fusion target. It should be appreciated that the actual gas-phase filling temperature can depend on the environment, including the other molecules in the system. For gas-phase filling, it should be appreciated that any hydrogen storage compound that sublimes at temperatures at which BNNT is stable may be used. When the AB coated BNNT material is cooled to room temperature, the AB remains as a stable coating on the BNNT material.

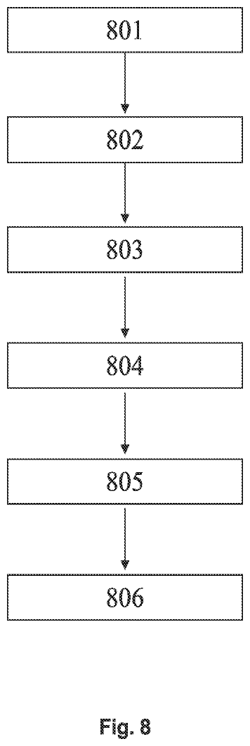

FIG. 8 is a flowchart showing a process for adding a hydrogen storage compound to a BNNT fusion target through a solution-phase additive process, according to one embodiment of the present approach. In step 801, the BNNTs and hydrogen storage compound are put into solution. The components may be in the same solution, or first dissolved in separate, compatible solvents. The BNNT material may be in any formfactor, such as a BNNT powder, a BNNT mat, a BNNT buckypaper, or a BNNT puffball, for example, prior to dissolution. In some embodiments, the BNNT material may have been processed to open the ends of some or most nanotubes in the BNNT material, thereby allowing the hydrogen storage compound to enter and coat the interior surfaces of the nanotubes (e.g., at a later step). In step 802, the hydrogen storage compound is dispersed into the BNNT material. For example, if the components are in separate solutions, then the separate solutions may be mixed. Alternatively, if the components are in the same solution, then the solution may be mechanically mixed using conventional mixing processes, such as sonication, agitation, and the like. In step 803, the hydrogen storage compound is given sufficient time to thoroughly disperse through and into the BNNT material. The time will necessarily depend on the particular embodiment. In step 804, after sufficient time to allow the hydrogen storage compound to disperse through the BNNT material, the solvent(s) are removed through one or more means known in the art, which may include evaporation, drying, filtration, and the like.

Steps 805 and 806 are generally the same as the xenon-addition steps for gas-phase filling processes. Generally, in step 805, the BNNT material filled with hydrogen storage compound is cooled to a temperature below the melting point of the high atomic number element. In step 806, after the target temperature is reached, the high atomic number element, as a gas, may be flowed into a chamber housing the cooled BNNT material filled with hydrogen storage compound. The specific processing conditions for xenon coating may be determined by the person having an ordinary level of skill in the art, with routine experimentation, for a particular embodiment. As with gas-phase additive processes, it should be appreciated that solution-phase processes may be repeated to increase the content of either or both the hydrogen storage compound and/or the high atomic number element, including building multiple layers of either or both components.

For solution-phase filling, the additive process involves placing the BNNT sample and hydrogen storage compound into solution. Depending on the solubility of the hydrogen storage compound, the components may be placed in the same solvent, or separate compatible solvents and then the separate solutions mixed. In some embodiments, the BNNT and hydrogen storage compound solution may be mixed, such as through sonication or other common methods of mixing solutions to improve filling the BNNT with the hydrogen storage compound. In some embodiments, the solution may be heated to improve filling the BNNT with the hydrogen storage compound. For example, using AB as the hydrogen storage compound, the AB may be dissolved in a solvent suitable for the AB, such as, e.g., water. Then the BNNT may either be directly added to the AB solution, or the BNNT may be separately added to the same or compatible solvent and then added to the AB solution. The contents are then allowed to interact in solution. In some embodiments, the AB and BNNT solution may be mixed or sonicated by typical lab methods, for anywhere from 5 min to 12 h or more, depending on the particular embodiment and process conditions. It should be appreciated that the person having ordinary skill in the art can determine the appropriate process conditions for a specific embodiment, using routine experimentation. In some embodiments the AB and BNNT solution may not be mixed. In some embodiments the solution of AB and BNNT may be heated to facilitate or accelerate the filling to a temperature up to the boiling point of the solvent or solvent system used. A minimum amount of solvent may be added to minimize the filling of the BNNTs with solvent. It should be appreciated that the reaction conditions, including solvents, concentrations, times, temperatures, reaction vessels, etc., may vary based on both the form factor of BNNTs and the identity of the filling molecule. For solution-based filling, any suitable material which dissolves in solvents compatible with BNNT may be used. In addition, if a high atomic number element other than xenon is used, it may be preferable to select one that goes into solution with the hydrogen storage compound and mixes at the same time as the hydrogen storage compound is added to the BNNTs.

In both gas-phase filling and solution-phase filling, the BNNTs may be in different form factor, including, e.g., powder, puffball, mats, buckypapers, or other form factors. If the ends of the BNNTs are open, then the AB may enter and fill or coat the interior of the BNNTs. The solvent may enter the BNNTs, which may be preferred in some embodiments to further encourage the hydrogen storage compound to enter into and coat the nanotube surfaces. In some embodiments, more than one type of filling molecule may be used in the reaction vessel at a time. In some embodiments, successive filling cycles may be used to fill and coat the nanotubes with more than one type of molecule. In some embodiments, the nanotube ends may be filled with another molecule to seal the ends and prevent molecules from escaping by a similar process to the hydrogen storage compound filling. The AB may also coat the outside of the BNNTs, which may be preferred in some embodiments. Further, the distribution of AB within the target does not have to be uniform. For example, the laser target interaction near the surface may primarily be used to create a wave of electrons that then accelerate protons deeper within the target. The efficiency of the loading may be controlled by means of a temperature gradient across the BNNT material. For example, a long BNNT mat may be heated such that it has a temperature gradient in order to create a gradient in the concentration of AB and thereby control the distribution of protons for the pB11 reaction. After filling with the hydrogen storage compound, the filled and coated BNNT material may be processed to remove material on exterior surfaces of the BNNTs, which may be preferred in some embodiments where having AB inside the BNNTs provides sufficient and preferred protons for the pB11 reaction. For example, the filled and coated BNNTs may be dried, washed, or heated to remove AB from exterior surfaces. The AB inside the BNNTs is somewhat protected from the any solvent being used and heating preferentially removes AB from the outside surfaces when done for short times as determined by observing the AB gas evolve.

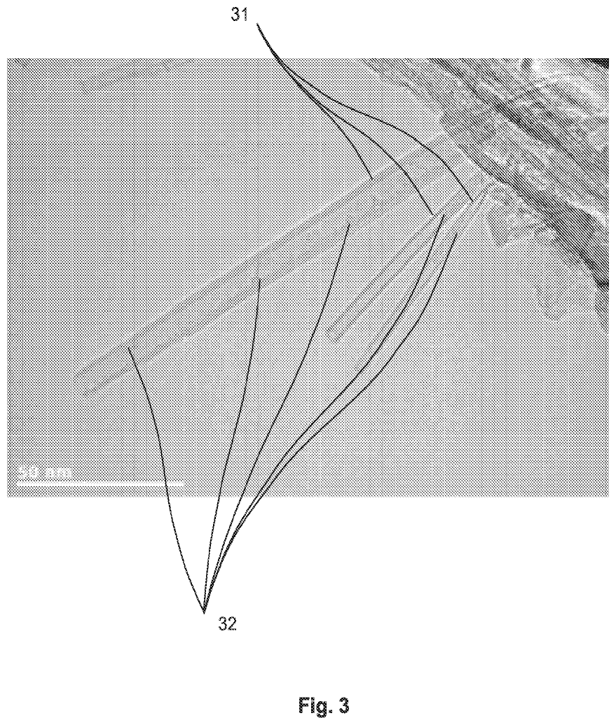

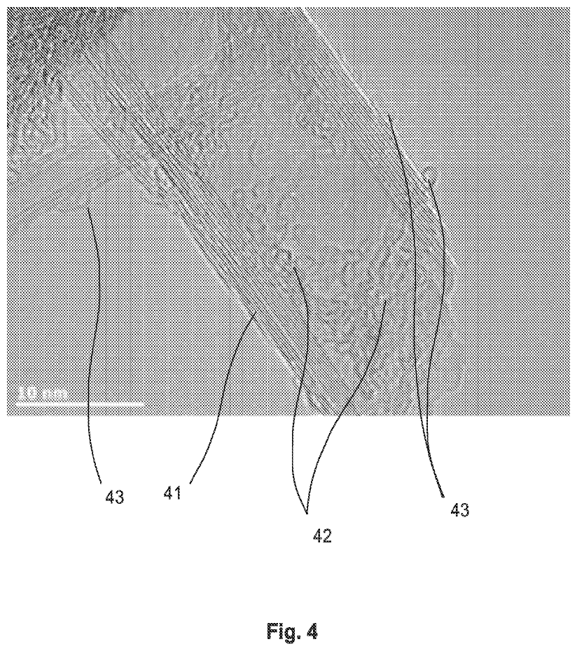

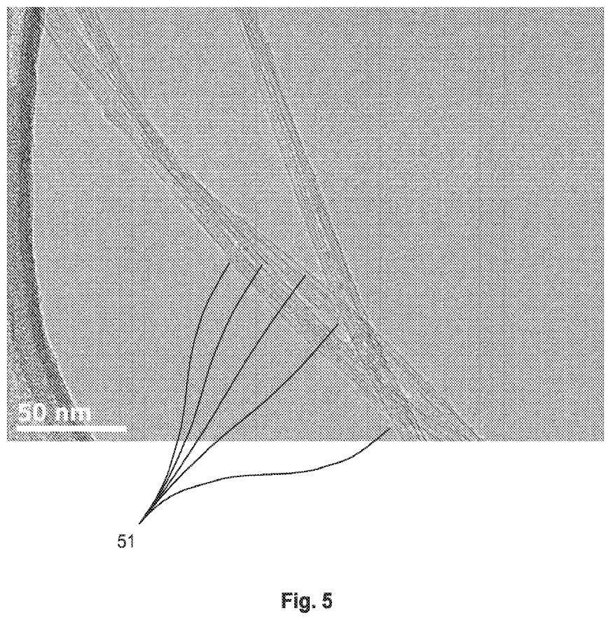

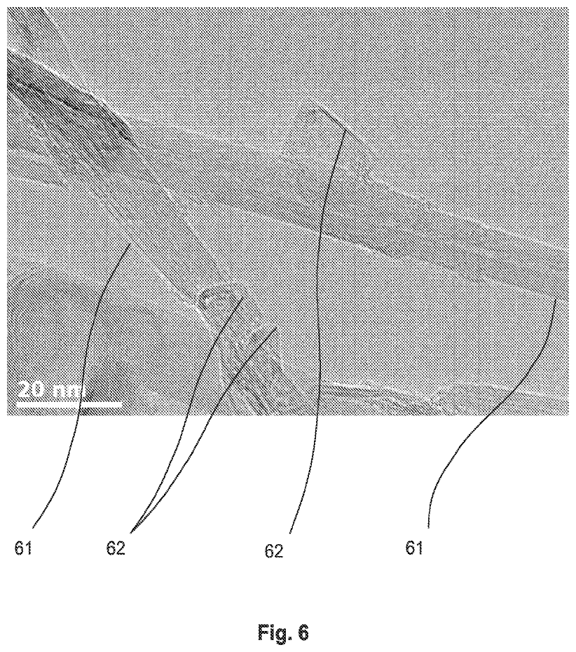

In demonstrative embodiments, the gas-phase loading of AB into BNNT has resulted in AB loadings over 20 wt % as determined by mass change measurement, for BNNT in multiple formfactors (e.g., puffballs, mats, buckypapers, and powders). Loading from 1 wt % to 20 wt % were experimented with, and the variation determined by the relative amounts of AB and BNNT used. FIGS. 3 and 4 are TEM images of BNNTs filled with AB according to an embodiment of the present approach. As seen in FIG. 3 (which includes a 50 nm scale), AB molecules 32 are present as a coating on the interior surfaces of the BNNTs 31. As seen in FIG. 4 (which includes a 10 nm scale), AB is present as a coating on both the interior 42 and exterior 43 of the BNNT 41. The FIG. 4 TEM shows a BNNT with 8-9 walls, which while less common in HTP BNNT material, are present. FIG. 5 shows a TEM of BNNTs 51 without AB present, and FIG. 6 shows a TEM of both BNNTs and BN nanocages without AB present. The deposition times and temperatures influence the interior vs. exterior distribution of the AB on the BNNTs.

Intense short pulse laser beams from infrared to x-ray are used at a number of facilities to investigate the properties of matter, create short pulses of intense secondary radiation, such as pulses of protons, and for example at the National Ignition Facility (NIF) to attempt to reach fusion conditions. As described herein, the inclusion of a high atomic number element in the fusion target, such as xenon, but not limited to xenon, can increase the electron densities and bremsstrahlung production of beneficial photons for many of the conditions, laser beams and associated targets of interest. The specific embodiments of BNNT with AB, and BNNT with both AB and xenon described herein, are demonstrative of the present approach, and are suitable as targets for pB11 fusion. While the AB directly contributes to the fusion process by providing the protons, the xenon indirectly contributes to the fusion process by providing an increase in electron density and an enhanced production of bremsstrahlung photons.

For nanomaterials to include carbon nanotubes (CNTs) and boron nitride nanotubes (BNNT), there have been multiple investigations of getting a variety of atoms and molecules to enter inside the nanotubes. Applications include, but are not limited, to fusion reactions, understanding the science of one dimensional or other arrays of atoms and molecules that may form within the nanotubes, utilization of the nanotubes to perform drug delivery for medical applications, use nanotubes for storage of hydrogen rich materials such as ammonia borane, and creation of advanced sensor devices that depend on the combination of the CNT or BNNT and the material being held within the nanotubes. Carbon based nano and micro structures to include those with carbon deuterium, CH₂, compounds have been utilized as targets in pulsed laser investigations from producing deuterium based fusion reactions and similar to pB11 fusion discussed above, these CH₂ based targets would benefit from the addition of xenon or other high atomic number element. Beyond the fusion reactions discussed above, pulsed lasers being a tool to investigate the structure and dynamics of these materials inside of nanotubes, may benefit from the inclusion of xenon or other high atomic number elements in the nanotubes as part of the pulsed laser target interactions. And further for xenon, it should have minimal chemical interaction with the other materials present within the nanotubes, although this is open to investigation and may not be an issue for many materials of interest.

The present approach may be embodied in forms other than as disclosed in the various embodiments, as will be appreciated by those having an ordinary level of skill in the art. The present embodiments are therefore to be considered in all respects as illustrative and not restrictive.

The terminology used in the description of embodiments of the present approach is for the purpose of describing particular embodiments only and is not intended to be limiting. As used in the description and the appended claims, the singular forms “a,” “an” and “the” are intended to include the plural forms as well, unless the context clearly indicates otherwise. The present approach encompasses numerous alternatives, modifications, and equivalents as will become apparent from consideration of the following detailed description.

It will be understood that although the terms “first,” “second,” “third,” “a),” “b),” and “c),” etc. may be used herein to describe various elements of the present approach, and the claims should not be limited by these terms. These terms are only used to distinguish one element of the present approach from another. Thus, a first element discussed below could be termed an element aspect, and similarly, a third without departing from the teachings of the present approach. Thus, the terms “first,” “second,” “third,” “a),” “b),” and “c),” etc. are not intended to necessarily convey a sequence or other hierarchy to the associated elements but are used for identification purposes only. The sequence of operations (or steps) is not limited to the order presented in the claims.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. All publications, patent applications, patents and other references mentioned herein are incorporated by reference in their entirety. In case of a conflict in terminology, the present specification is controlling.

Also, as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the present approach described herein can be used in any combination. Moreover, the present approach also contemplates that in some embodiments, any feature or combination of features described with respect to demonstrative embodiments can be excluded or omitted.

As used herein, the transitional phrase “consisting essentially of” (and grammatical variants) is to be interpreted as encompassing the recited materials or steps “and those that do not materially affect the basic and novel characteristic(s)” of the claim. Thus, the term “consisting essentially of” as used herein should not be interpreted as equivalent to “comprising.”

Unless otherwise stated, the term “about,” as used herein when referring to a measurable value, such as, for example, an amount or concentration and the like, is meant to encompass variations of ±10%, ±5%, ±1%, ±0.5%, or even ±0.1% of the specified amount. A range provided herein for a measurable value may include any other range and/or individual value therein.

Having thus described certain embodiments of the present approach, it is to be understood that the scope of the appended claims is not to be limited by particular details set forth in the above description as many apparent variations thereof are possible without departing from the spirit or scope thereof as hereinafter claimed.

What is claimed is:

1. An ¹¹B fusion target comprising:
boron nitride nanotubes (BNNT) having a plurality of nanotubes, each nanotube having an exterior nanotube surface and an interior nanotube surface;
a hydrogen storage compound comprising ammonia borane; and
a high atomic number element.

2. The ¹¹B fusion target of claim 1, wherein the hydrogen storage compound further comprises a compound selected from the group consisting of methane, ammonia, alane (Al₃H₉), a boron hydride, diborane (B₂H₆), a metal hydride, MgH₂, NaAlH₄, LiAlH₄, LiH, LaNi₅H₆, TiFeH₂, palladium hydride, an organoborane, and a hydrocarbon.

3. The ¹¹B fusion target of claim 1, wherein the high atomic number element comprises xenon.

4. The ¹¹B fusion target of claim 1, wherein the hydrogen storage compound comprises an ammonia borane coating on external nanotube surfaces of the BNNT material.

5. The ¹¹B fusion target of claim 4, wherein the hydrogen storage compound further comprises an ammonia borane coating on interior nanotube surfaces of the BNNT material.

6. The ¹¹B fusion target of claim 1, wherein the hydrogen storage compound is dispersed throughout the BNNT material.

7. The ¹¹B fusion target of claim 4, wherein the high atomic number element comprises a coating on at least a portion of the ammonia borane coating on external nanotube surfaces of the BNNT material.

8. The ¹¹B fusion target of claim 5, wherein the high atomic number element comprises a coating on at least a portion of the ammonia borane coating on external nanotube surfaces of the BNNT material and at least a portion of the ammonia borane coating on interior nanotube surfaces of the BNNT material.

9. The ¹¹B fusion target of claim 1, wherein the high atomic number element is dispersed throughout the BNNT material

10. The ¹¹B fusion target of claim 8, wherein the hydrogen storage compound comprises ammonia borane, and the high atomic number element comprises xenon.

11. An ¹¹B fusion target comprising boron nitride nanotubes (BNNT) with a coating of at least one of ammonia borane and xenon, the target for use with intense pulsed laser beams for achieving proton ¹¹B fusion.

12. A method for forming an ¹¹B fusion target, the method comprising:
dispersing a hydrogen storage compound comprising ammonia borane into a boron nitride nanotube (BNNT) material in a reaction vessel, wherein the BNNTs have a plurality of nanotubes, each nanotube having an exterior nanotube surface and an interior nanotube surface; and
dispersing a high atomic number element into the BNNT material.

13. The method of claim 12, wherein the reaction vessel is under vacuum.

14. The method of claim 12, wherein the hydrogen storage compound further comprises a compound selected from the group consisting of methane, ammonia, alane (Al₃H₉), a boron hydride, diborane (B₂H₆), a metal hydride, MgH₂, NaAlH₄, LiAlH₄, LiH, LaNi₅H₆, TiFeH₂, palladium hydride, an organoborane, and a hydrocarbon.

15. The method of claim 12, wherein the high atomic number element is xenon.

16. The method of claim 12, wherein the hydrogen storage compound is heated to a temperature sufficient to evaporate the hydrogen storage compound and form an evaporated hydrogen storage compound in the reaction vessel.

17. The method of claim 12, wherein the reaction vessel is cooled to a temperature sufficient to sublimate the evaporated hydrogen storage compound onto surfaces of the BNNT material, to form an ammonia borane-coated BNNT material.

18. The method of claim 17, wherein the high atomic number element has a melting point, and the ammonia borane-coated BNNT material is cooled to a temperature below the melting point of the high atomic number element.

19. The method of claim 12, wherein the hydrogen storage compound and the BNNT material are in solution comprising at least one solvent.

20. The method of claim 19, wherein dispersing the hydrogen storage compound and the BNNT material comprises mixing the solution.

21. The method of claim 19, further comprising removing the solvent to form an ammonia borane-coated BNNT material.

22. The method of claim 21, wherein the high atomic number element has a melting point, and the ammonia borane-coated BNNT material is cooled to a temperature below the melting point of the high atomic number element.
